(19) United States
(12) Patent Application Publication
(10) Pub. No.: US 2012/0032543 A1
(43) Pub. Date: Feb. 9, 2012

(54) OIL COMPOSITION COMPRISING FUNCTIONALIZED NANOPARTICLES

(75) Inventors: Soma Chakraborty, Houston, TX (US); Ashley Leonard, Houston, TX (US); Gaurav Agrawal, Aurora, CO (US); Ketankumar K. Sheth, Tulsa, OK (US)

(73) Assignee: BAKER HUGHES INCORPORATED, Houston, TX (US)

(21) Appl. No.: 13/021,137

(22) Filed: Feb. 4, 2011

Related U.S. Application Data
(63) Continuation-in-part of application No. 12/693,569, filed on Jan. 26, 2010, now Pat. No. 8,076,809.
(60) Provisional application No. 61/147,378, filed on Jan. 26, 2009.

(51) Int. Cl. C10M 169/04; H02K 7/08; B82Y 99/00

(52) U.S. Cl. 310/90; 508/110; 508/113; 508/154; 508/167; 508/161; 977/773; 977/902; 977/734; 977/735; 977/750; 977/752

(57) ABSTRACT

An improved oil composition is disclosed. The oil composition includes a base oil comprising a hydrocarbon, the base oil having a base thermal conductivity. The oil composition also includes a first additive comprising a plurality of derivatized first additive nanoparticles dispersed within the base oil to form a modified oil having a modified thermal conductivity, wherein the modified thermal conductivity is greater than the base thermal conductivity. Alternately, an improved oil composition includes a base oil comprising a hydrocarbon and a first additive comprising a plurality of derivatized first additive nanoparticles dispersed within the base oil to form a modified oil comprising a stabilized suspension of the derivatized first additive nanoparticles in the base oil.

### CROSS REFERENCE TO RELATED APPLICATIONS

This application is a Continuation In Part of and claims priority to U.S. application Ser. No. 12/693,569 filed Jan. 26, 2010, which in turn claims priority to U.S. Provisional Patent Application Ser. No. 61/147,378 filed on Jan. 26, 2009, both of which are incorporated herein by reference in their entirety.

### BACKGROUND

The invention relates to an oil composition, particularly a lubricating oil composition for use in a submersible electric motor. Oils are used for a variety of applications, including providing lubrication for engines and motors to extend lifetime and prevent failure. Oils that are used as lubricants provide lubrication between two moving surfaces, such as for example, bearings and other metal surfaces, to improve motor efficiency and improve motor run life. Additionally, lubricants are useful for carrying away heat that is generated within the motor, thereby reducing the operating temperature. Finally, oil may function as an electrical insulator providing electrical isolation between the stator and rotor in an electric motor.

Oils are generally selected based upon a desired viscosity at a specified operating temperature. Preferably, oils are selected to ensure efficient operation of a motor or engine at desired operating temperatures by providing sufficient viscosity to provide lubrication, while at the same time having sufficient lubrication to minimize friction. Additionally, oils preferably have good thermal conductivity to ensure they efficiently carry away heat generated by the operation of the motor. Finally, it is preferable that the oil have a high electrical resistance.

In certain oil recovery applications, such as for example, steam assisted gravity drainage (SAGD) or the production of heavy oil, increased pumping temperatures result in increased operating temperatures inside the motor. Generally, it is believed that the increase in temperature inside the motor is partially the result of the heat transfer characteristics of the oil. Thus, a temperature rise within the motor will typically be lower if the oil within the motor has a higher heat transfer capacity. It is believed that for every 10° C. increase in the operating temperature of a motor, the reliability and lifetime of the motor can be reduced by approximately 50%. Thus, there is a need for oils that may provide increased heat transfer, lubricity, electrical insulation or isolation or viscocity control, or a combination thereof

### SUMMARY

In an exemplary embodiment, an oil composition is disclosed. The oil composition includes a base oil comprising a hydrocarbon, the base oil having a base thermal conductivity. The oil composition also includes a first additive comprising a plurality of derivatized first additive nanoparticles dispersed within the base oil to form a modified oil having a modified thermal conductivity, wherein the modified thermal conductivity is greater than the base thermal conductivity.

In another exemplary embodiment, an oil composition includes a base oil comprising a hydrocarbon and a first additive comprising a plurality of derivatized first additive nanoparticles dispersed within the base oil to form a modified oil comprising a stabilized suspension of the derivatized first additive nanoparticles in the base oil.

In yet another embodiment, an electric motor, is disclosed. The motor includes a rotatable shaft, a stator and a rotor disposed within the stator and spaced from the stator by a running clearance therebetween, the rotor configured for rotation of the shaft. The motor also includes an oil composition disposed in the running clearance, the oil composition comprising a base oil comprising a hydrocarbon, the base oil having a base thermal conductivity, and a first additive comprising a plurality of derivatized first additive nanoparticles dispersed within the base oil to form a modified oil comprising a stabilized suspension of the derivatized nanoparticles in the base oil and having a modified thermal conductivity, wherein the modified thermal conductivity is greater than the base thermal conductivity.

### BRIEF DESCRIPTION OF THE DRAWINGS

Referring now to the drawings wherein like elements are numbered alike in the several Figures:

FIG. 1 is cross-sectional view of an exemplary embodiment of a downhole, submersible pump as disclosed herein configured to use an exemplary oil composition as also disclosed herein.

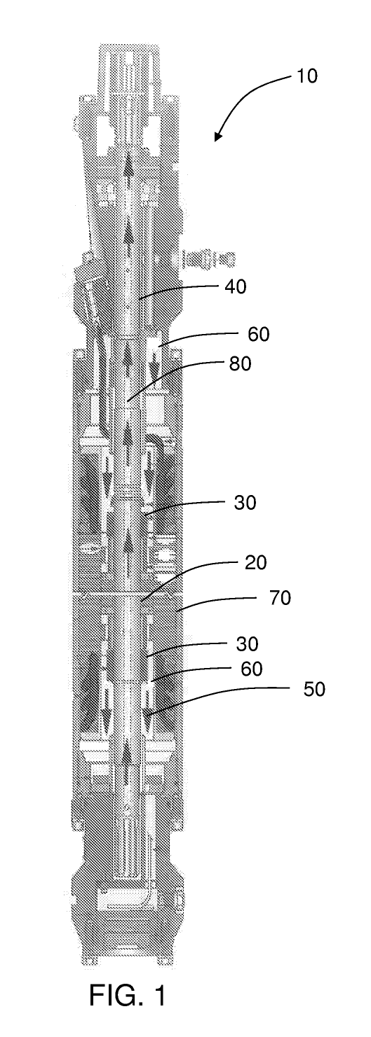

### DETAILED DESCRIPTION

Although the following detailed description contains many specific details for purposes of illustration, it is understood that one of ordinary skill in the art will appreciate that many examples, variations and alterations to the following details are within the scope and spirit of the invention. Accordingly, the exemplary embodiments of the invention described herein are set forth without any loss of generality to, and without imposing limitations on, the claimed invention.

In one aspect of the present invention, a lubricant composition having improved thermal, electrical and tribological properties is provided. Generally, the lubricant composition includes a base oil and at least one additive therein in the form of functionalized additive nanoparticles dispersed therein, preferably as a stabilized, non-settling suspension. Functionalized additive nanoparticles include at least one functional group that is chemically bonded to the additive nanoparticle. A functional group as used herein may include any suitable number of atoms. The chemical bonds used to bond the functional group to the additive nanoparticle may include any suitable chemical bond, including covalent bonds, ionic bonds and metallic bonds. Functionalized additive nanoparticles may also be referred to herein as derivatized additive nanoparticles.

Suitable oils for the base oil are hydrocarbon-based and may be natural oils, including distillate oils, or synthetic oils, or a combination thereof As used herein, natural oil refers to a naturally occurring liquid or crude oil comprising a mixture of hydrocarbons having various molecular weights, which may have been recovered from a subsurface rock formation, and which may have been subjected to a refining process by distillation or otherwise. As used herein, synthetic oil refers to a hydrocarbon liquid that comprises chemical compounds not originally present in a natural oil, but were instead artificially synthesized from other compounds.

The base oil may be any natural oil, including various petroleum distillates, or synthetic oil in any rheological form, including liquid oil, grease, gel, oil-soluble polymer composition or the like, particularly the mineral base stocks or synthetic base stocks used in the lubrication industry, e.g., Group I (solvent refined mineral oils), Group II (hydrocracked mineral oils), Group III (severely hydrocracked oils, sometimes described as synthetic or semi-synthetic oils), Group IV (polyalphaolefins (PAOs)), and Group V (esters, naphthenes, and others). Examples include polyalphaolefins, synthetic esters, and polyalkylglycols.

Synthetic lubricating oils include hydrocarbon oils and halo-substituted hydrocarbon oils such as polymerized and interpolymerized olefins (e.g., polybutylenes, polypropylenes, propylene-isobutylene copolymers, chlorinated polybutylenes, poly(1-octenes), poly(1-decenes), etc., and mixtures thereof); alkylbenzenes (e.g., dodecylbenzenes, tetradecylbenzenes, dinonylbenzenes, di-(2-ethylhexyl), benzenes, etc.); polyphenyls (e.g., biphenyls, terphenyls, alkylated polyphenyls, etc.), alkylated diphenyl, ethers and alkylated diphenyl sulfides and the derivatives, analogs and homologs thereof and the like. Alkylene oxide polymers and interpolymers and derivatives thereof where the terminal hydroxyl groups have been modified by esterification, etherification, etc. constitute another class of known synthetic oils.

Another suitable class of synthetic oils comprises the esters of dicarboxylic acids (e.g., phthalic acid, succinic acid, alkyl succinic acids and alkenyl succinic acids, maleic acid, azelaic acid, suberic acid, sebacic acid, fumaric acid, adipic acid, alkenyl malonic acids, etc.) with a variety of alcohols (e.g., butyl alcohol, hexyl alcohol, dodecyl alcohol, 2-ethylhexyl alcohol, ethylene glycol diethylene glycol monoether, propylene glycol, etc.). Specific examples of these esters include dibutyl adipate, di(2-ethylhexyl) sebacate, di-hexyl fumarate, dioctyl sebacate, diisooctyl azelate, diisodecyl azealate, dioctyl phthalate, didecyl phthalate, dicicosyl sebacate, the 2-ethylhexyl diester of linoleic acid dimer, the complex ester formed by reacting one mole of sebacic acid with two moles of tetraethylene glycol and two moles of 2-ethylhexanoic acid, and the like.

Esters useful as synthetic oils also include those made from C₅ to C₁₂ monocarboxylic acids and polyols and polyol ethers such as neopentyl glycol, trimethylolpropane, pentaerythritol, dipentaerythritol, tripentaerythritol, etc. Other synthetic oils include liquid esters of phosphorus-containing acids (e.g., tricresyl phosphate, trioctyl phosphate, diethyl ester of decylphosphonic acid, etc.), polymeric tetrahydrofurans and the like.

In an exemplary embodiment, the additive may include a plurality of nanoparticles. As used herein, nanoparticles refers to particles or agglomerates having an average mean diameter less than about 1000 nm, more particularly about 250 nm or less, and even more particularly about 200 nm or less. They may also range from about 0.01 to about 500 nm, more particularly about 0.1 to 250 nm, even more particularly about 5 to about 150 nm, and yet even more particularly from about 10 to about 30 nm. In another exemplary embodiment, the additive may include a plurality of nanoparticles or a plurality of microparticles, or a combination thereof As used herein, microparticles may include particles having an average particle size of greater than or equal to about 1 micrometer (μm), more particularly about 1 μm to about 250 μm, even more particularly about 2 μm to about 200 μm, and even more particularly about 1 μm to about 150 μm.

Additive microparticles may be formed from any suitable additive material. In an exemplary embodiment, additive microparticles may be formed from the same material as additive nanoparticles. In another exemplary embodiment, additive microparticles may be formed from a different material than that of additive nanoparticles. In one exemplary embodiment, additive nanoparticles comprise nanodiamond particles and additive microparticles comprise diamond microparticles.

Exemplary additive nanoparticles or microparticles may include, but are not limited to; those are selected from a group consisting of a fullerene, graphene, graphite, nanodiamond, metallic oxide, metal sulfonate, molybdenum disulfide, tungsten disulfide, alumoxane, metallic carbide, metallic nitride, and combinations thereof These include, but are not limited to, carbon nanotubes; carbon nano-onions; graphite nanoparticles, graphene nanoparticles or nanofluids; diamond nanoparticles or nanofluids; silicon dioxide nanoparticles or organic functionalized derivatives thereof; aluminum oxide nanoparticles or organic functionalized derivatives thereof; metal oxide nanoparticles (such as, for example, magnesium oxide, calcium oxide or copper oxide); metal sulfonates nanoparticles (such as, for example, magnesium sulfonate or calcium sulfonate); tungsten disulfide nanoparticles or nanotubes; molybdenum disulfide nanoparticles or nanotubes; alumoxane nanoparticles or functionalized derivatives thereof (such as, for example, carboxylate-alumoxane); beryllium oxide nanoparticles and nanotubes; carbide nanoparticles (such as, for example, silicon carbide, tungsten carbide or boron carbide); and nitrides (such as, for example, aluminum nitride); and combinations thereof Preferably, the nanoparticle additive is at least slightly soluble in the lubricant composition. Exemplary shapes of the individual nanoparticles can include single or multi-walled nanotubes, spheres/balls, ribbons, and donut/wheel shapes. The particles can have a long dimension of up to about 250 nm in diameter or length, preferably up to about 200 nm in diameter or length. The particles may have a unimodal or multimodal size distribution.

Carbon nanoparticles may include various graphite, graphene, single-wall or multi-walled nanotubes, fullerene or nanodiamond nanoparticles, or a combination thereof Fullerene carbon nanoparticles may include buckeyballs, buckeyball clusters, buckeypapers, single-wall nanotubes or multi-wall nanotubes, or a combination thereof Inorganic nanoparticles may include, for example, various metallic carbide, nitride, carbonate or oxide nanoparticles, or a combination thereof

The nanoparticles or microparticles used herein may have any suitable shape, including various spherical, tubular and plate-like or planar shapes. These shapes may be symmetrical, irregular, or elongated shapes. They may have a low aspect ratio (i.e., largest dimension to smallest dimension) of less than 10 and approaching 1 in various spherical particles. They may also have a two-dimensional aspect ratio (i.e., diameter to thickness for elongated nanoparticles such as nanotubes or diamondoids; or ratios of length to width, at an assumed thickness or surface area to cross-sectional area for plate-like nanoparticles such as, for example, nanographene or nanoclays) of greater than or equal to 10, specifically greater than or equal to 100, more specifically greater than or equal to 200, and still more specifically greater than or equal to 500. Similarly, the two-dimensional aspect ratio for such nanoparticles may be less than or equal to 10,000, specifically less than or equal to 5,000, and still more specifically less than or equal to 1,000.

Fullerene nanoparticles, as disclosed herein, may include any of the known cage-like hollow allotropic forms of carbon possessing a polyhedral structure. Fullerenes may include, for example, polyhedral buckeyballs of from about 20 to about 100 carbon atoms. For example, C₆₀ is a fullerene having 60 carbon atoms and high symmetry (D₅ₕ), and is a relatively common, commercially available fullerene. Exemplary fullerenes include, for example, C₃₀, C₃₂, C₃₄, C₃₈, C₄₀, C₄₂, C₄₄, C₄₆, C₄₈, C₅₀, C₅₂, C₆₀, C₇₀, C₇₆, and the like. Fullerene nanoparticles may also include buckeyball clusters. A carbon nanotube is a carbon-based, tubular fullerene structure having open or closed ends and which may be inorganic or made entirely or partially of carbon, and may also include components such as metals or metalloids. Nanotubes, including carbon nanotubes, may be single-wall nanotubes (SWNTs) or multi-wall nanotubes (MWNTs).

A graphite nanoparticle or microparticle includes a cluster of plate-like or planar sheets of graphite, in which a stacked structure of one or more layers of the graphite, which has a plate-like two dimensional structure of fused hexagonal rings with an extended delocalized π-electron system, layered and weakly bonded to one another through π-π stacking interaction. Graphene nanoparticles, may be a single sheet or several sheets of graphite having nano-scale dimensions, such as an average particle size (average largest dimension) of less than e.g., 500 nanometers (nm), or in other embodiments may have an average largest dimension less than about 1000 nm. Nanographene may be prepared by exfoliation of nanographite or by catalytic bond-breaking of a series of carbon-carbon bonds in a carbon nanotube to form a nanographene ribbon by an “unzipping” process, followed by derivatization of the nanographene to prepare, for example, nanographene oxide.

Diamondoids may include carbon cage molecules such as those based on adamantane (C₁₀H₁₆), which is the smallest unit cage structure of the diamond crystal lattice, as well as variants of adamantane (e.g., molecules in which other atoms (e.g., N, O, Si, or S) are substituted for carbon atoms in the molecule) and carbon cage polyadamantane molecules including between 2 and about 20 adamantane cages per molecule (e.g., diamantane, triamantane, tetramantane, pentamantane, hexamantane, heptamantane, and the like).

The nanoparticles or microparticles may include a metal or metalloid (metallic) boride such as titanium boride, tungsten boride and the like; a metal or metalloid carbide such as tungsten carbide, silicon carbide, boron carbide, or the like; a metal or metalloid nitride such as titanium nitride, boron nitride, silicon nitride, aluminum nitride or the like; or a metal or metalloid oxide such as aluminum oxide, silicon oxide, beryllium oxide or the like.

The additive nanoparticles or microparticles may be functionalized to form a derivatized nanoparticle or derivatized microparticle using either inorganic or organic materials. For example, the nanoparticles or microparticles described herein may be functionalized by being coated with a chemically bonded inorganic material, including an inorganic material selected from a group consisting of a metal boride, carbide, nitride, carbonate, bicarbonate, or combinations thereof As another example, the nanoparticles may also be functionalized to form a derivatized nanoparticle that includes an organic functional group selected from a group consisting of a carboxy, epoxy, ether, ketone, amine, hydroxy, alkoxy, alkyl, lactone, aryl functional group, a polymeric or oligomeric group thereof, and combinations thereof.

A variety of functional groups can be appended to the additive nanoparticles or microparticles. The functional groups may include, but are not limited to, hydrocarbon derivatives. In certain embodiments, the functional group can be an alkyl, alkenyl, aromatic hydrocarbon, or mixtures or derivatives of those groups, or polymers of such. Preferable alkyl groups may include single molecules between one and fifty carbon atoms and may be arranged in a straight chain or branched configuration, or may include polymeric species containing between about 10 and 20,000 carbon atoms. Optionally, the functional group may include at least one heteroatom selected from oxygen, sulfur and nitrogen. In certain preferred embodiments, the functional group may be hydrophobic.

In an exemplary embodiment, the derivatized or functionalized nanoparticles are characterized by chemical bonding, including ionic, covalent or metallic bonding, of the functionalizing material, such as an organic group, to the nanoparticles, particularly to the surface of the nanoparticles. This is in contrast, for example, to conventional adsorption of dispersants onto the surface of various additive nanoparticles used in various base oils.

In certain embodiments, the nanoparticle or microparticle additive may be present in an amount up to about 30% by volume of the lubricant composition. Alternatively, the nanoparticle additive may be present in an amount up to about 20% by volume. In other embodiments, the nanoparticle additive may be present in an amount up to about 10% by volume. In certain embodiments, the nanoparticle additive may be present in an amount between 0.001 and 15% by volume, preferably between about 0.001 and 10% by volume. Alternatively, the nanoparticle additives may be present in an amount between about 0.001 and 5% by volume. In certain embodiments, the nanoparticle additives may be present in an amount of between about 0.1 ppm and about 5% by volume, alternatively in an amount between about 0.1 ppm and about 10% by volume, or alternatively between about 0.1 ppm and about 15% by volume. In certain embodiments, the nanoparticle additive is present in an amount of at least 0.1 ppm, alternatively at least about 1 ppm, alternatively at least about 10 ppm, or at least about 100 ppm.

In certain embodiments, at least two nanoparticle additives may be present in the lubricant composition, wherein the concentration of a first nanoparticle additive is between about 0.001 and 10% by volume, and the concentration of a second nanoparticle additive is between about 0.001 and 10% by volume. Alternatively, in embodiments that include at least two nanoparticle additives, the total concentration of the nanoparticle additives may be up to about 20% by volume, preferably between about 0.001 and 15% by volume. In certain embodiments, the at least two nanoparticle additives are present in an amount of at least about 0.1 ppm, alternatively at least about 1 ppm, alternatively at least about 10 ppm

In certain embodiments, the lubricant composition may include more than two nanoparticle additives, wherein the total concentration of additives may be up to about 30% by volume, preferably up to about 20% by volume and even more preferably up to about 10% by volume. In other embodiments having more than two nanoparticle additives, the total concentration of additives may be between about 0.001 and 15% by volume.

The lubricant composition may optionally include additional chemical compounds, including but not limited to, anti-oxidants, detergents, friction modifiers, viscosity modifiers, corrosion inhibiting additives, anti-wear additives, anti-foam agents, surfactants, conditioners, and dispersants.

In another aspect, a method for producing hydrocarbon based lubricants having improved thermal, electrical and tribological properties are provided. The method generally includes the steps of providing a base oil and adding to the base oil a desired amount of nanoparticles operable to result in an improvement of at least one property selected from an increased lubricity, an increased heat transfer capacity, or an increased electrical insulation or isolation, or any other fluid property, such as for example, control of viscosity. As such, the additives, including the additive nanoparticles, may be characterized as a lubricity enhancement medium, an electrical insulation enhancement medium or a viscosity control medium. For example, in certain experiments, thermal conductivity of the nanoparticles, nanotubes and nano-onions have been higher than the thermal conductivity of the base material from which they are manufactured. Without wishing to be bound by any specific theory, this increased thermal conductivity may be due to an increased surface area of the nanoparticles, nanotubes and nano-onions. The thermal conductivity is directly proportional to the heat transfer. In general, an increase in thermal conductivity results in an increase in the heat transfer through the matrix. Nanoparticle thermal properties have been proven to be enhanced when added to a matrix material, such as for example, an oil, or polymeric material. Previous studies have shown dramatic increases in thermal conductivity when nanoparticles have been added to water or other solutions. Similarly, other physical properties, such as for example, the lubricity and electrical resistance of the base oil, can be increased by addition of certain nanoparticles, nanotubes and nano-onions. The computational modeling shows that improving thermal conductivity of the oil by 20-50% may decrease the motor internal temperature by up to about 10-20° C. In certain embodiments, to achieve a proper balance of desired properties of the base oil, a combination of different amounts of nanoparticles, nanotubes and nano-onions can be added to the base oil. In certain embodiments, the method may include adding additives in a concentration of up to about 30% by volume, preferably up to about 20% by volume, and more preferably up to about 10% by volume.

In one exemplary embodiment, wherein the bottom hole temperature of a well being produced is greater than about 200° F., a submersible electric motor having a plurality of rotors and bearings mounted on a shaft and a long stator is provided. The rotor can be a hollow cylinder made of a stack of laminations, a copper bar and end rings, which is supported at each end by the bearings. A running clearance located between the internal diameter of the stator and outside diameter of the rotor includes oil, which provides lubrication for the bearings and carries away heat generated by friction and rotor and windage losses and acts as an electrical resistor between the stator and the rotor. The oil based lubricant employed in the submersible motor includes up to about 30% by volume of nanoparticles. Alternatively, the oil based lubricant may include up to about 20% by volume of nanoparticles. In other embodiments, the oil based lubricant may include up to about 10% by volume of nanoparticles. The nanoparticles may include, but are not limited to, carbon nanotubes; carbon nano-onions; graphite nanoparticles, nanotubes or nanofluids; diamond nanoparticles or their derivatives; diamond nanofluids; silicon dioxide nanoparticles or organic functionalized derivatives thereof; aluminum oxide nanoparticles or organic functionalized derivatives thereof; metal oxide nanoparticles (such as, for example, magnesium oxide, calcium oxide or copper oxide); metal sulfonates nanoparticles (such as, for example, magnesium sulfonate or calcium sulfonate); molybdenum disulfide nanoparticles or nanotubes; tungsten disulfide nanoparticles or nanotubes; alumoxane nanoparticles or functionalized derivatives thereof (such as, for example, carboxylate-alumoxane); beryllium oxide nanoparticles and nanotubes; carbide nanoparticles (such as, for example, silicon carbide, tungsten carbide or boron carbide); and nitrides (such as, for example, aluminum nitride); and combinations thereof In certain embodiments, the functionalized derivative is an organic moiety.

In an exemplary embodiment, the modified oil compositions described herein comprise substantially non-settling suspensions or colloidal suspensions. As used herein, substantially non-settling may mean that substantially all of the additive nanoparticles remain permanently suspended in the base oil. Substantially all may also include a predetermined portion of the additive nanoparticles, such as, for example, about 90 percent of the nanoparticles, or more particularly about 92 percent of the nanoparticles, or even more particularly about 95 percent of the nanoparticles. In another exemplary embodiment, the oil compositions may be substantially non-settling for a predetermined service interval, such as a desired period in which the oil may remain downhole in service in a tool or component in the wellbore. In yet another exemplary embodiment, the predetermined service interval may be at least 3 months, and more particularly at least 6 months, and even more particularly at least 1 year.

In one embodiment, an oil composition of the types described herein, is used in a downhole electrical submersible pumping system (ESP) that is disposed in a wellbore, wherein the wellbore may intersect a subterranean formation. The ESP includes on a lower end a motor 10, a seal (not shown), and a pump (not shown) on an upper end. The motor 10 and pump are separated by the seal. The motor includes a rotor 20, or a plurality of rotors 20, and bearings 30 mounted on a motor shaft 40, wherein said shaft is coupled to and drives the pump. The motor shaft is coupled to the pump via a seal section, and the motor shaft 40 is coupled to a shaft in the seal section, which in turn is coupled to a shaft in the pump. The rotor 20 can be a hollow cylinder made of a stack of laminations, a copper bar and end rings, which is supported at each end by the bearings 30. The motor 10 is filled with a lubricating oil 50 having a composition as described herein and includes a running clearance 60 located between the internal diameter of the stator 70 and outside diameter of the rotors 20 wherein the oil 50 provides lubrication for the bearings 30 and carries away heat generated by friction and rotor 20 and windage losses and acts as an electrical insulator between the stator 70 and the rotor 20. The oil within the running clearance 50 can be circulated within the motor 10 through a hole 80 in the shaft 40. The oil 50 in the motor is also used in the seal, and communicates and circulates between the seal and motor 10. The oil used in the seal assists with the cooling of the thrust bearing in the seal. The oil 50 within the motor 10 and seal can include up to about 30% by volume of nanoparticles. Alternatively, the oil-based lubricant may include up to about 20% by volume of nanoparticles. In other embodiments, the oil-based lubricant may include up to about 10% by volume of nanoparticles. The nanoparticles may include, but are not limited to, carbon nanotubes; carbon nano-onions; graphite nanoparticles, nanotubes or nano fluids; diamond nanoparticles or their derivatives; diamond nanofluids; silicon dioxide nanoparticles or organic functionalized derivatives thereof; aluminum oxide nanoparticles or organic functionalized derivatives thereof; metal oxide nanoparticles (such as, for example, magnesium oxide, calcium oxide or copper oxide); metal sulfonates nanoparticles (such as, for example, magnesium sulfonate or calcium sulfonate); molybdenum disulfide nanoparticles or nanotubes; tungsten disulfide nanoparticles or nanotubes; alumoxane nanoparticles or functionalized derivatives thereof (such as, for example, carboxylate-alumoxane); beryllium oxide nanoparticles and nanotubes; carbide nanoparticles (such as, for example, silicon carbide, tungsten carbide or boron carbide); and nitrides (such as, for example, aluminum nitride); and combinations thereof In certain embodiments, the functionalized derivative is an organic moiety.

In an alternate embodiment of the invention, a method of lubricating an electric submersible pump assembly disposable within a wellbore is provided. The assembly includes a motor, wherein the motor includes a plurality of rotors and bearings mounted on a shaft, a stator external to the plurality of rotors, and a running clearance between an internal diameter of the stator and an external diameter of the rotor. The motor is coupled to a pump via a seal section, and the motor shaft is coupled to a shaft in the seal section, which in turn is coupled to a shaft in the pump. The method includes the step of mixing a plurality of nanoparticles, such as those described herein, into a lubricating oil, then dispensing the lubricating oil into motor and the seal section. The nanoparticles can be present in the lubricating oil in an amount up to about 10% by volume, alternately up to about 20% by volume, or up to about 30% by volume. In certain embodiments, the nanoparticles are present in the lubricating oil, which may be a petroleum-based oil or a synthetic oil, in an amount between about 0.1 and 10% by volume.

### EXAMPLES

A commercially available nanodiamond cluster (75 mg, having an average particle size of about 75 nm, available from NanoDiamond Products) is suspended in 100 ml of liquid ammonia in a dry ice/acetone bath. Lithium metal (175 mg) is added to the liquid ammonia solution, whereupon the solution attains a blue color indicating dissolution of the lithium metal. When the addition of lithium is complete, the solution is stirred for 30 minutes, and 1-iodododecane (I—CH₂—(CH₂)₁₀—CH₃) (6.5 ml) is then added slowly to the ammonia slurry of metalized nanodiamond.

The resulting solution is allowed to react for four hours at room temperature. after which ammonia is slowly removed to isolate the solid product. The resulting solid material is isolated to yield 1-dodecyl derivatized nanodiamond.

Thermogravimetric analysis (TGA). The functionalized nanodiamond was evaluated by thermogravimetric analysis (TGA) to confirm the presence of covalently bound n-dodecyl groups by comparison of TGA plots of weight loss versus temperature for nanodiamond (ND), nanodiamond in a mechanically-mixed admixture with 1-iodododecane (ND+Do-I), and n-dodecyl-modified nanodiamond (Do-ND). The nanodiamond control (ND) did not exhibit significant change in weight with increasing temperature, where both the nanodiamond-1-iodododecane admixture and the dodecyl-modified nanodiamond each show a weight loss with increasing temperature. The TGA plot, obtained at a heating rate of 10° C./minute, shows a clear increase in degradation temperature from the admixture of ND+Do-I, with an onset temperature of about 100° C. and a maximum rate of change at about 190° C., to ND-Do, with an onset temperature of about 200° C. and a maximum rate of change at about 260° C. Thus, based on the comparison, it can be seen that the dodecyl groups are chemically bound (e.g., covalently) to the nanodiamond after derivatization.

Infrared analysis (IR). A comparison of the infrared spectra using a Fourier Transform Infrared Spectrophotometer (FT-IR) for the unmodified nanodiamond and for the n-dodecyl modified nanodiamond was also performed. The nanodiamond prior to derivatization had a complex spectrum including associated water O—H stretching at about 3300 cm⁻¹ and C—H olefinic stretching at >3000 cm⁻¹ as well as C—H alkyl stretching at <3000 cm⁻¹, carboxylic acid and anhydride carbonyl stretching at about 1700-1800 cm⁻¹, and C═C stretching at about 1600-1670 cm⁻¹, whereas after derivatization, the FT-IR spectrum shown for the dodecyl-modified nanodiamond showed prominent and sharp new peaks at 2800-2980 cm⁻¹ and 725-1470 cm⁻¹, corresponding to alkyl C—H stretch and deformation modes, respectively. This provided further confirmation that the nanodiamond had been derivatized to include dodecyl groups.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

Although the present invention has been described in detail, it should be understood that various changes, substitutions, and alterations can be made hereupon without departing from the principle and scope of the invention. Accordingly, the scope of the present invention should be determined by the following claims and their appropriate legal equivalents.

The singular forms “a”, “an” and “the” include plural referents, unless the context clearly dictates otherwise.

Ranges may be expressed herein as from about one particular value, and/or to about another particular value. When such a range is expressed, it is to be understood that another embodiment is from the one particular value and/or to the other particular value, along with all combinations within said range.

“Optional” or “optionally” means that the subsequently described event or circumstance can or cannot occur, and that the description includes instances where the event occurs and instances where it does not. As used herein, “combination” is inclusive of blends, mixtures, alloys, reaction products, and the like. All references are incorporated herein by reference.

The terms “first,” “second,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity).

While one or more embodiments have been shown and described, modifications and substitutions may be made thereto without departing from the spirit and scope of the invention. Accordingly, it is to be understood that the present invention has been described by way of illustrations and not limitation.

1. An oil composition, comprising:
a base oil comprising a hydrocarbon, the base oil having a base thermal conductivity; and
a first additive comprising a plurality of derivatized first additive nanoparticles dispersed within the base oil to form a modified oil having a modified thermal conductivity, wherein the modified thermal conductivity is greater than the base thermal conductivity.

2. The oil composition of claim 1, wherein the first additive provides the modified oil with at least one modified oil property that is greater than a base oil property, the modified oil property selected from a group consisting of lubricity, electrical resistance, viscosity, elasticity, and combinations thereof.

3. The oil composition of claim 1, further comprising a second additive comprising a plurality of second additive nanoparticles or microparticles, or a combination thereof, dispersed within the base oil, wherein the second additive nanoparticles or microparticles are derivatized or underivatized, or a combination thereof.

4. The oil composition of claim 3, wherein the second additive provides the modified oil with at least one modified oil property that is greater than a base oil property, the modified oil property selected from a group consisting of thermal conductivity, lubricity, electrical resistance, viscosity, elasticity, and combinations thereof.

5. The oil composition of claim 1, wherein the modified oil comprises up to about 10% by volume of the first additive nanoparticles.

6. The oil composition of claim 3, wherein the modified oil comprises up to about 10% by volume of a sum of the first additive nanoparticles and the second additive nanoparticles.

7. The oil composition of claim 1, wherein the base oil comprises a natural oil or a synthetic oil, or a combination thereof.

8. The oil composition of claim 1, wherein the first nanoparticles are selected from a group consisting of a fullerene, graphene, graphite, nanodiamond, metallic oxide, metal sulfonate, molybdenum disulfide, tungsten disulfide, alumoxane, metallic carbide, metallic nitride, and combinations thereof.

9. The oil composition of claim 1, wherein each of the derivatized first additive nanoparticles is derivatized to include at least one functional group selected from the group consisting of carboxy, epoxy, ether, ester, ketone, amine, hydroxy, alkoxy, alkyl, aralkyl, alkene, alkyne, lactone, aryl, functionalized polymeric or oligomeric groups, or a combination thereof.

10. The oil composition of claim 3, wherein each of the derivatized first additive nanoparticles is derivatized to include at least one functional group selected from the group consisting of carboxy, epoxy, ether, ester, ketone, amine, hydroxy, alkoxy, alkyl, aralkyl, alkene, alkyne, lactone, aryl, functionalized polymeric or oligomeric groups, or a combination thereof.

11. The oil composition of claim 8, wherein the fullerene is selected from a group consisting of a buckeyball, buckeyball cluster, single-wall nanotube, multi-wall nanotube, and combinations thereof.

12. The oil composition of claim 8, wherein the metallic oxide is selected from a group consisting of aluminum oxide, silicon oxide, beryllium oxide, and combinations thereof.

13. The oil composition of claim 3, wherein the first additive nanoparticles or the second additive nanoparticles, or both of them, are selected from a group consisting of a fullerene, graphene, graphite, nanodiamond, metallic oxide, metal sulfonate, molybdenum disulfide, tungsten disulfide, alumoxane, metallic carbide, metallic nitride, and combinations thereof.

14. The oil composition of claim 1, wherein the modified oil comprises a substantially non-settling suspension.

15. The oil composition of claim 14, wherein the substantially non-settling suspension is substantially non-settling for a predetermined service interval.

16. The oil composition of claim 15, wherein the predetermined service interval is at least 3 months.

17. The oil composition of claim 1, wherein the modified thermal conductivity is substantially greater than the base thermal conductivity.

18. The oil composition of claim 1, wherein the modified thermal conductivity is at least 20 percent greater than the base thermal conductivity.

19. An oil composition, comprising:
a base oil comprising a hydrocarbon; and
a first additive comprising a plurality of derivatized first additive nanoparticles dispersed within the base oil to form a modified oil comprising a stabilized suspension of the derivatized first additive nanoparticles in the base oil.

20. The oil composition of claim 19, wherein the first additive further comprises a plurality of first additive microparticles, and wherein the first additive microparticles are derivatized or underivatized, or a combination thereof.

21. The oil composition of claim 20, wherein the base oil has a base thermal conductivity and the modified oil has a modified thermal conductivity, and wherein the modified thermal conductivity is substantially greater than the base thermal conductivity.

22. The oil composition of claim 20, further comprising a second additive comprising a plurality of second additive nanoparticles or microparticles, or a combination thereof, dispersed within the base oil

23. The oil composition of claim 22, wherein at least a portion of the second additive nanoparticles or microparticles, or a combination thereof, are derivatized.

24. The oil composition of claim 19, wherein the first additive nanoparticles or microparticles, or a combination thereof, comprise diamond.

25. An electric motor, comprising:
a rotatable shaft;
a stator;
a rotor disposed within the stator and spaced from the stator by a running clearance therebetween, the rotor configured for rotation of the shaft; and
an oil composition disposed in the running clearance, the oil composition comprising a base oil comprising a hydrocarbon, the base oil having a base thermal conductivity, and a first additive comprising a plurality of derivatized first additive nanoparticles dispersed within the base oil to form a modified oil comprising a stabilized suspension of the derivatized nanoparticles in the base oil and having a modified thermal conductivity, wherein the modified thermal conductivity is greater than the base thermal conductivity.
